(19) United States
(12) Patent Application Publication
(10) Pub. No.: US 2026/0122108 A1
(43) Pub. Date: Apr. 30, 2026

(54) SYSTEMS AND METHODS FOR AUTOMATIC SECURITY RULE GENERATION

(71) Applicant: Micro Focus LLC, Wilmington, DE (US)

(72) Inventors: Manohar Chamaraju, Bangalore (IN); Vasudevan Gajjala, Bangalore (IN); Naveen Manoharan, Bangalore (IN)

(73) Assignee: Micro Focus LLC, Wilmington, DE (US)

(21) Appl. No.: 18/929,473

(22) Filed: Oct. 28, 2024

(51) Int. Cl. H04L 9/40; G06F 40/16; G06F 40/58

(52) U.S. Cl. CPC H04L 63/20; G06F 40/16; G06F 40/58

(57) ABSTRACT

Correlation rules (or simply, rules) evaluate events received from networked components. The rules may fail to keep up with the events received and leave a network and/or the networked components vulnerable. Systems and methods are provided wherein an event is processed by rules, when known. When not known, and not associated with normal activity, the event is converted into a natural language sentence by a large language model (LLM), which is then provided to a sentence transformer to vectorize the sentence and associated events. A neural network then determines a degree of fit to a number of rules and selects the best fitting rule(s). If no rule is a sufficient match, a new/modified rule may be generated.

### FIELD OF THE DISCLOSURE

The invention relates generally to systems and methods for monitoring components on a network and particularly to automatically generating/modifying rules based on the analysis of the network events.

### BACKGROUND

Networks and the devices that form various parts of the network are commonly monitored for threats. The threats can be mere annoyances, such as unsolicited emails (e.g., spam); attacks (e.g., malware, ransomware, etc.); and theft (e.g., acquiring or accessing data or systems). Additionally, many threats are more nuanced and designed to identify vulnerabilities in a system that may be exploited by a more aggressive attack at a later time. Often a vulnerability may be an unacceptable risk that has an identified potential to increase the likelihood and/or success of another attack. For example, a user with a short password may pose an unacceptable risk.

Prior art systems rely on rules. When one or more events are received by a network monitoring device, they are evaluated by one or more rules. If the one or more rules evaluate the event(s) and determine a threat or risk is present, an action specified by the rule is triggered. For example, an internet protocol (IP) address that is the source of an attack may be discovered by a rule(s) and added to a blacklist. All subsequent packets received from the blocked IP address are then discarded.

### SUMMARY

In a SIEM (security information and event management) system, all known threats are detected using correlation rules, which may be used interchangeably herein with the simpler form, "rule." Correlation rules detect threats by looking at the anatomy of events, such as by looking into specific fields of events along with sequence of events and by applying filter on events. Filters will have specific information about what piece of information needs to be looked into with respect to an event. A new events comes into the system, the event having specific piece of data that rule is looking for, then an existing correlation rule will detect those events and generates alert/incident.

Correlation rules are static in nature and most of the time rules are defined to detect well-known threats. If a new set of events comes to a system which may be part of a known threat but is slightly different, such as in terms of field values for which the events correlation rule filter is defined, the correlation rule will not detect these new events as threat.

In order to determine that these events are a threat, one needs to identify these events manually first and then update the correlation rule. Then, the next time the events is encountered, the event is processed by the updated correlation rule and handled as a threat. Identifying new events and/or the values for an event's specific data attributes is a process that needs to be added to an existing correlation rule, which is a manual process. As a result, updates are often not timely, may contain errors, or may be omitted entirely.

Relying on rules to manage the security for a network provides a sufficient level of security in many situations. However, a security operations center (SOC) analyst must be vigilant and promptly update the rules when new threats are discovered. This can quickly become overwhelming as large systems will generate millions of events every hour. Additionally, a system may receive a threat that has not been previously encountered or anticipated, known as a zero-day threat. The number of events and rules, and ensuring the rules are sufficiently broad to catch all threats, must be managed against the consequences of triggering a rule unnecessarily. As an extreme example, a network would be immune from all threats if it were disconnected from the Internet or discarded all packets. However, such an overly restrictive approach would render the network, and the components attached to the network, partially or completely useless. Therefore, while it is critical to take action to stop known or suspected threats from impairing a network, the network must enable legitimate activity to proceed normally. It is also critical to identify new activities that may be harmful to a network and quickly mitigate new threats.

These and other needs are addressed by the various embodiments and configurations of the present invention. The present invention can provide a number of advantages depending on the particular configuration. These and other advantages will be apparent from the disclosure of the invention(s) contained herein.

In certain embodiments, an artificial intelligence (AI) based solution is provided, which identifies a new rule wherein a new set of events are applied to an existing rule, a new rule is created that applies to an existing set of events, or both. A new rule may be entirely new or a modification to an existing rule.

The AI is provided with a stream of events and determines that one or more of the events therein that have an anatomy that is similar but not identical, and therefore not applicable, to those handled by a particular rule. The AI then determines if the similarity is above a threshold, and therefore such events should be treated in a similar manner. For example, the AI may determine that a port-specific attack, such as on port 80, should be thwarted as being a similar attack on a different port, such as port 8443, due to an above-threshold similarity. As a result, a new rule is created to thwart the attack on the different ports. The determination of what is, and is not, similar is discussed more completely with respect to certain embodiments described below.

In another embodiment, a new set of events that are neither similar to events which have triggered the rule nor similar to events which are normal (i.e., not part of any threat) may be, or be a portion of, a new threat (e.g., zero-day threats) that do not have any correlation rule currently defined. Such events may be suspect and action may be automatically taken or raised as a concern for manual intervention by a SOC analyst.

In another embodiment, new events are fed to a large language model (LLM) and receive therefrom a recommendation for new correlation rules.

In another embodiment, the LLM is used to summarize a number of events. The summary of events is generated such as to help an SOC analyst to know certain information of the events without the need to examine all fields of multiple events and manually correlate the events to a rule.

In another embodiment, a training process is provided wherein alerts are provided to a neural network directly or after processing by a large language model (LLM). When provided to an LLM the alerts are first converted to natural language by a sentence transformer and vectorized by the LLM. The neural network is trained for each vector representation of the alert sentence and correlation rule that triggered the alert. Additionally or alternatively, events that caused the alert are used to train the neural network and the correlation rule which was triggered by the corresponding events.

In another embodiment, no event will match an existing correlation rule. In such a case, the events are considered normal and not a threat. Such events are aggregated and passed to the LLM to generate a meaningful summary and/or converted to vector form using a sentence transformer. Such events are then provided to the neural network as a training event as non-threatening events.

In some aspects, the techniques described herein relate to a method, including: accessing an event on a computer network; converting the event into a natural language sentence; converting the natural language sentence into a vector representation; embedding a number of events associated with the event into the vector representation; providing the vector representation to a neural network and, in response, receiving a generated rule therefrom; and applying the generated rule to a network monitor receiving events from the computer network and evaluating the events with the generated rule.

In some aspects, the techniques described herein relate to a method, wherein converting the event into the natural language sentence includes providing the event to a large language model (LLM) and receiving therefrom the natural language sentence.

In some aspects, the techniques described herein relate to a method, wherein converting the natural language sentence into the vector representation further includes providing the natural language sentence to a sentence transformer and receiving therefrom the vector representation.

In some aspects, the techniques described herein relate to a method, further including: training the neural network including providing the neural network with the vector representation and receiving therefrom a number of nodes, each node of the number of nodes corresponding to a correlation rule currently deployed in the computer network.

In some aspects, the techniques described herein relate to a method, wherein training the neural network further includes providing a number of vector representations to the neural network, further including providing at least the vector representation and a number of correlation rules including at least the correlation rule associated with the event to the neural network.

In some aspects, the techniques described herein relate to a method, wherein training the neural network further includes providing the neural network with the number of events correlated with the corresponding correlation rule of the number of correlation rules that were triggered by the event.

In some aspects, the techniques described herein relate to a method, wherein receiving the event includes receiving a number of prior events from the computer network, evaluating at least one of the number of prior events with at least one existing rule, and receiving the event from the evaluation thereof.

In some aspects, the techniques described herein relate to a method, wherein converting the event into the natural language sentence includes converting the event into a complete sentence including a subject and a predicate.

In some aspects, the techniques described herein relate to a system, including: a network interface to a computer network; and a microprocessor coupled to a computer memory including instructions that, when read by the microprocessor, cause the microprocessor to perform: accessing, via the network interface, an event on the computer network; converting the event into a natural language sentence; converting the natural language sentence into a vector representation; embedding a number of events associated with the event into the vector representation; providing the vector representation to a neural network and, in response, receiving a generated rule therefrom; and applying the generated rule to a network monitor receiving events from the computer network and evaluating the events with the generated rule.

In some aspects, the techniques described herein relate to a system, wherein converting the event into the natural language sentence includes providing the event to a large language model (LLM) and receiving therefrom the natural language sentence.

In some aspects, the techniques described herein relate to a system, wherein converting the natural language sentence into the vector representation further includes providing the natural language sentence to a sentence transformer and receiving therefrom the vector representation.

In some aspects, the techniques described herein relate to a system, further including: training the neural network including providing the neural network with the vector representation and receiving therefrom a number of nodes, each node of the number of nodes corresponding to a correlation rule currently deployed in the computer network.

In some aspects, the techniques described herein relate to a system, wherein training the neural network further includes providing a number of vector representations to the neural network, further including providing at least the vector representation and a number of correlation rules including at least the correlation rule associated with the event to the neural network.

In some aspects, the techniques described herein relate to a system, wherein training the neural network further includes providing the neural network with the number of events correlated with the corresponding correlation rule of the number of correlation rules that were triggered by the event.

In some aspects, the techniques described herein relate to a system, wherein receiving the event includes receiving a number of prior events from the computer network, evaluating at least one of the prior events with at least one existing rule, and receiving the event from the evaluation thereof.

In some aspects, the techniques described herein relate to a non-transitory computer readable medium including instructions that, when read by a machine, cause the machine to perform: accessing an event on a computer network; converting the event into a natural language sentence; converting the natural language sentence into a vector representation; embedding a number of events associated with the event into the vector representation; providing the vector representation to a neural network and, in response, receiving a generated rule therefrom; and applying the generated rule to a network monitor receiving events from the computer network and evaluating the events with the generated rule.

In some aspects, the techniques described herein relate to a non-transitory computer readable medium, wherein the instructions to cause the machine to perform converting the event into the natural language sentence further include instructions to cause the machine to perform providing the event to a large language model (LLM) and receive therefrom the natural language sentence.

In some aspects, the techniques described herein relate to a non-transitory computer readable medium, wherein instructions to cause the machine to perform converting the natural language sentence into the vector representation further include instructions to cause the machine to perform providing the natural language sentence to a sentence transformer and receive therefrom the vector representation.

In some aspects, the techniques described herein relate to a non-transitory computer readable medium, further including instructions to cause the machine to perform training the neural network including providing the neural network with the vector representation and receiving therefrom a number of nodes, each node of the number of nodes corresponding to a correlation rule currently deployed in the computer network.

In some aspects, the techniques described herein relate to a non-transitory computer readable medium, wherein the natural language sentence includes converting the event into a complete sentence including a subject and a predicate.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases "at least one," "one or more," "or," and "and/or" are open-ended expressions that are both conjunctive and disjunctive in operation. For example, each of the expressions "at least one of A, B, and C," "at least one of A, B, or C," "one or more of A, B, and C," "one or more of A, B, or C," "A, B, and/or C," and "A, B, or C" means A alone, B alone, C alone, A and B together, A and C together, B and C together, or A, B, and C together.

The term "a" or "an" entity refers to one or more of that entity. As such, the terms "a" (or "an"), "one or more," and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a data flow in accordance with embodiments of the present disclosure;

FIG. 3 depicts a system in accordance with embodiments of the present disclosure;

FIG. 4 depicts a system in accordance with embodiments of the present disclosure; and

FIG. 5 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

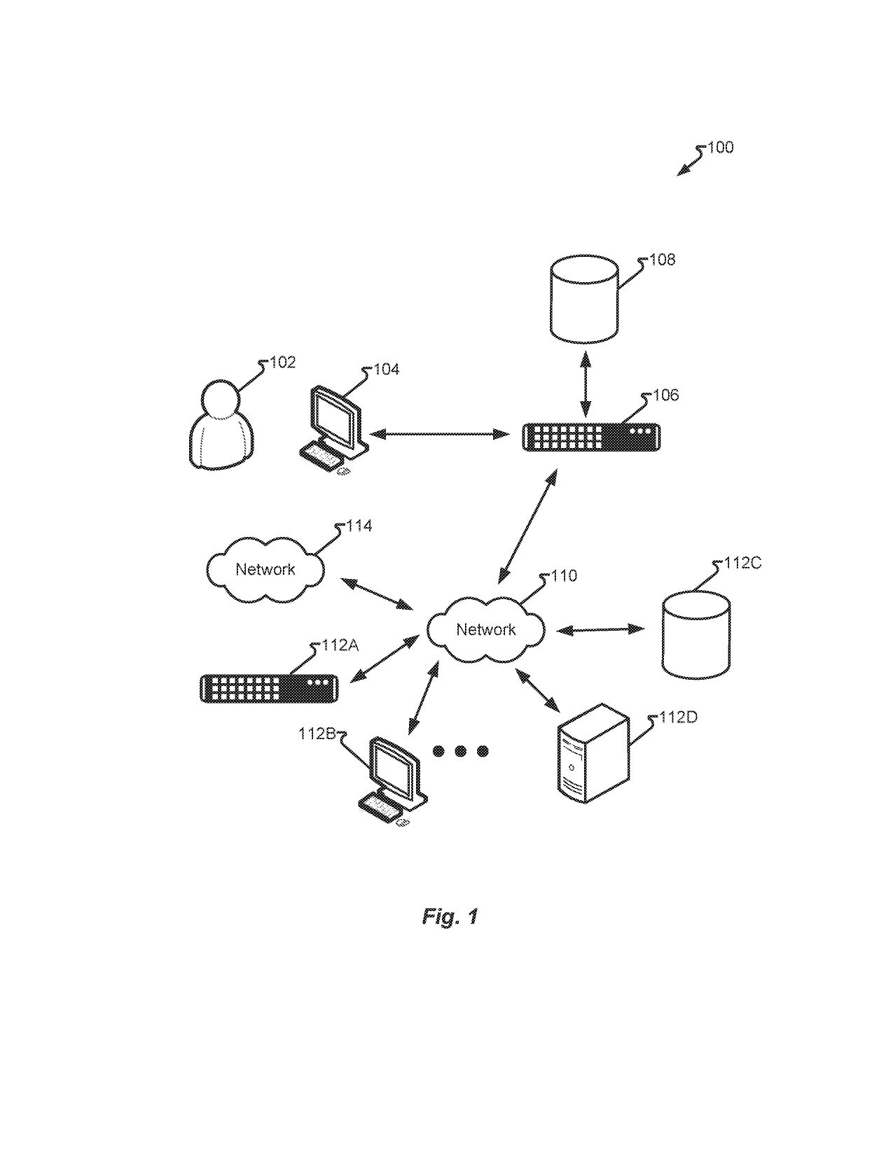

FIG. 1 depicts system 100 in accordance with embodiments of the present disclosure. In one embodiment, system 100 illustrates various computing, data storage, and/or networking components interconnected, such as via a network 110. It should be appreciated that system 100 illustrates one topology and that other topologies may be utilized without departing from the scope of the embodiments herein. For example, certain components may provide a single service, in one embodiment, or multiple services, such as when combined with another component, in another embodiment. Similarly, a single service may be provided by a plurality of components. As a further option, components may be networked via network 110 directly or indirectly (e.g., rely on a direct connection to another component(s), which in turn is networked via network 110).

In one embodiment, network 110 facilitates connections between various components 112. Components 112 are variously embodied and may include, but are not limited to, computer components, such as server 112A, personal computer 112B, print server 112D, and/or other computing devices (e.g., blades, arrays, integrated devices, etc.). Components may include data storage devices, such as data storage appliance 112C and/or other data storage devices. Components may further comprise devices providing network services which may include, but are not limited to, hubs, switches, routers, etc. Server 106 may execute a monitoring service, such as to directly monitor activities on network 110 (and components 112), intercept data between components attached to network 110 and/or traffic to and from network 114 (e.g., the Internet) and/or to passively receive event messages therefrom.

In many systems, the number of events received by server 106 may number in the millions. Data storage 108 may be used to store events, whether indefinitely or for a period of time, and/or summaries or other indicia of one or more events. Operator 102 may use computer 104 to access events from server 106 and/or from data storage 108. Computer 104 may execute a service to help organize, summarize, and/or receive configuration instructions from operator 102.

Server 106 may receive events and execute a correlation rule(s). The correlation rule correlates one or more events to a particular action. For example, a single failed login event may not justify a response beyond the rested login failing. However, if there are a number of login attempts within a period of time, such as five within five minutes, then a rule may consider such events reporting the failed login as a threat rather than a user misremembering or mistyping their password. Accordingly, server 106 may determine that the device and/or user credentials are under attack and take action, such as suspending the device or associated user account such that no further attempts to gain access will be permitted. The user may seek secondary authentication, such as by calling a network administrator or security personnel to be re-authenticated if found to be justified. Otherwise, the user account or device may be treated as compromised or potentially compromised and denied access to network 110 and/or other services. The foregoing is one of many thousands of scenarios wherein event(s) are evaluated by a rule and a response is triggered as a result of the evaluation.

Rules, while beneficial, can be "gamed," whether intentionally or not. For example, a bad actor may know that a user account will be locked if five login attempts are made within five minutes. Accordingly, the bad actor may limit the attempts to log in to four every five minutes. Similarly, a misconfiguration may cause some failed logins to be reported as a "failure" event whereas other failed logins are reported as "deny" events. As a result, the events evaluated by a rule may be similar but not identical and, therefore, may not trigger the rule. For example, a bad actor may attempt to log in to a first component 112 using an incorrect (e.g., guessed) password, and in response trigger a "login failure" event that is received by computer 104. However, the bad actor may then attempt to log in to a second component 112 using a different incorrect password and, in response, trigger a "login denied" event that is received by computer 104. In the prior art, the rule may determine that five login "failures" within five minutes will trigger the rule, but since the login "denied" events are not "failure" events, they are not counted. Manually maintaining all the rules is a tedious, resource-intensive, and error-prone activity. Events may appear to protect components 112 but fail to do so, such as in the above example, where "failure" logins are counted but "deny" logins are not. Other events may reflect a new attack (e.g., a zero-day attack) to which the existing rules are unprepared to handle and often require time for manual mitigation.

As will be described more completely with respect to the embodiments that follow, server 106 may execute (or cause to be executed on a different server (not shown)) an artificial agent that determines when a rule is needed to protect the system. The needed rule may be a modification to an existing rule and/or an entirely new rule. As a result, server 106 may monitor components 112 with existing rules as well as determine when the pattern of events indicates a new rule is needed and automatically create a new rule or modify an existing rule for deployment to monitor events associated with components 112, network 110, network 114, and/or other components.

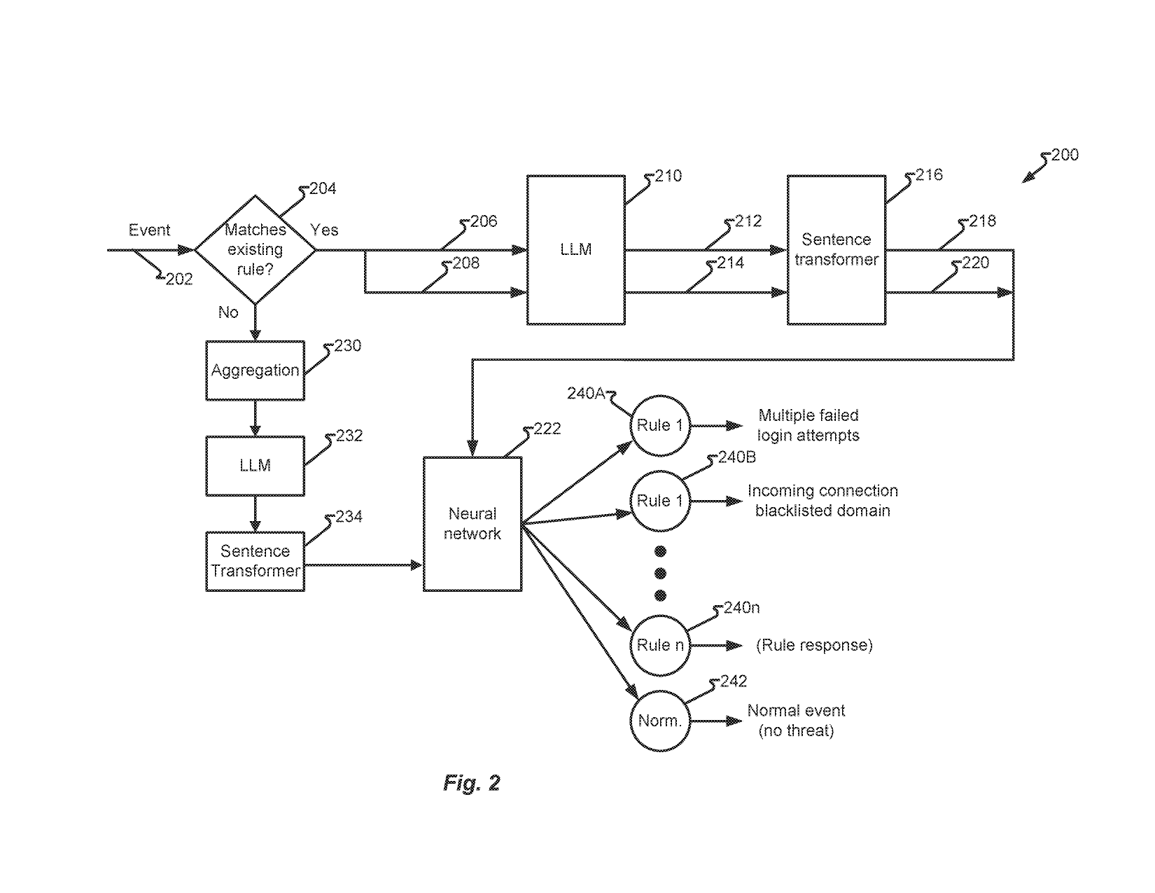

FIG. 2 depicts data flow 200 in accordance with embodiments of the present disclosure. In one embodiment, the operations illustrated by data flow 200 may be performed entirely or in part by a server (e.g., server 106). Additionally or alternatively, components, such as other servers (not shown), may be utilized to perform one or more operations of data flow 200. A data storage (e.g., data storage 108) may be used to store and/or provide access to data to any of the one or more servers providing operations illustrated by data flow 200.

In one embodiment, an event 202 is received and evaluated in test 204. Event 202 may be a single event of a stream of a number of events. Test 204 then determines if event 202 matches an existing rule. Event 202, when determined to not match any existing rule in test 204, is then subject to aggregation 230. Aggregation 230 may combine event 202 with other events, such as events received, and similarly be found to not match an existing rule by test 204 within a previously determined period of time (e.g., one or two minutes, etc.). Accordingly, one of ordinary skill in the art will appreciate that event 202, even though described in the singular form, may apply herein to a plurality of events.

Next, LLM 232 receives the aggregated event (or singular event) and generates a description of the event as a sentence (e.g., comprising a subject, such as a particular component 112, and predicate, such as a failed login attempt). LLM 232 then provides the sentence to sentence transformer 234, which then generates a vector representation of the event. The vector representation of the event is then provided to neural network 222 and, therefrom, a response is determined. Neural network 222 then determines a recommended rule based on a probability of each output node (e.g., rules 240A-240n or normal event rule 242). For example, neural network 222 may determine rule 240A has a "0.8" probability of being true; rule 240B has a "0.6" probability of being true; rule 240n has a "0.1" probability of being true; and normal event rule 242 has a "0.1" probability of being true. As the preceding example illustrates, probabilities may or may not equal "1.0". For example, more than two rules may be true (i.e., have a probability greater than a previously determined threshold, such as "0.5"). When event 202 is normal (e.g., not associated with any existing rule), then aggregation 230, LLM 232, sentence transformer 234, and neural network 222 will lead to normal event rule 242, which triggers normal event decision.

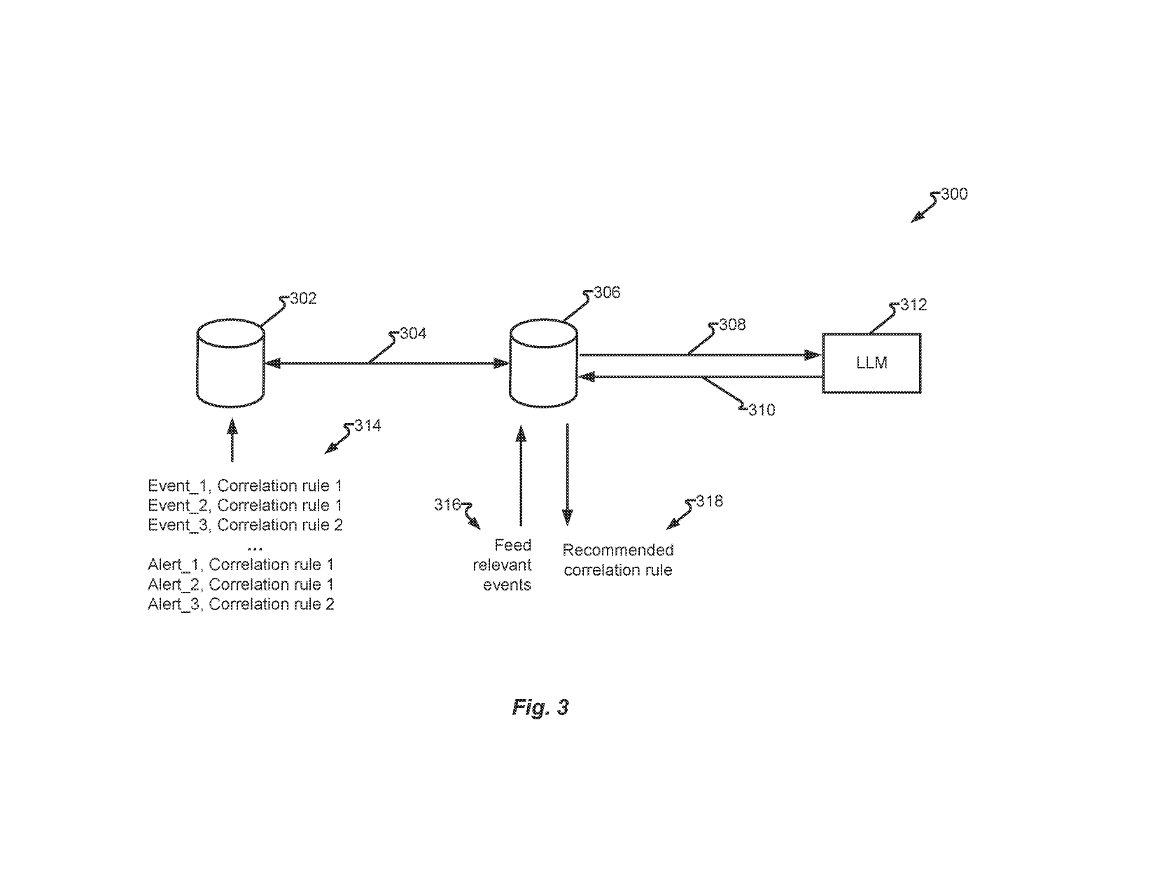

In another embodiment, none of the resulting output rules 240A-240n and normal event rule 242 have a sufficient probability, such as all are below "0.5" or another threshold (e.g., "0.1"). When such a result occurs, event 202 (and optionally the aggregation of event 202 with other events by aggregator 230) is determined to be not sufficiently similar to the rules determined in test 204. Accordingly, event 202 may be a new threat (or may be a portion thereof). As a result, event 202 may be identified as requiring a new or modified rule and creating the new or modified rule automatically (see FIG. 3) or providing the event and/or recommendations for manual evaluation.

Test 204 then determines that the event matches an existing rule used to identify a threat (whether an actual threat or potential threat) or other non-normal behavior. As an alternative, test 204 may be modified to utilize rules to determine if an event is not a threat or other normal behavior wherein events that do not match are considered a threat. Test 204, when true, identifies one or more events as a threat or other incident (e.g., failure, suspicious activity, etc.).

In another embodiment, alert (or incident) 206 is then provided to LLM 210 along with the event 208 that triggered the alert. LLM 210 then creates a description of threat 212 in sentence form which, along with event 214, are then provided to sentence transformer 216. Sentence transformer 216 then produces a vector representation of threat 218 and a vector representation of event 220, which are provided to neural network 222.

In another embodiment, LLM 210 and LLM 232 are the same large language model. In another embodiment, sentence transformer 234 and sentence transformer 216 are the same sentence transformer.

FIG. 3 depicts system 300 in accordance with embodiments of the present disclosure. In one embodiment, system 300 utilizes retrieval augmented generation (RAG) to filter the recommendation for creating/updating a rule. RAG, in its basic form, is a known technique. In one embodiment, RAG records are maintained in database 302 which comprises a number of records associating rules with events and (optionally) vice versa. Events and/or alerts 314 are provided to database 302 as a portion of exchange 304. Vector database 306 is provided with subject events 316, which may be known or suspected to be part of a threat. Vector database 306 fetches events, alerts, and correlation rules from database 302, as a portion of exchange 304, based on the subject events 316.

Vector database 306 provides to LLM 312, as a portion of exchange 308, the events, alerts, and correlation rules and a prompt to recommend new/updated rules and obtain from LLM 312 a recommended correlation rule, as a portion of exchange 310. The recommended correlation rule is returned as the recommended correlation rule 318.

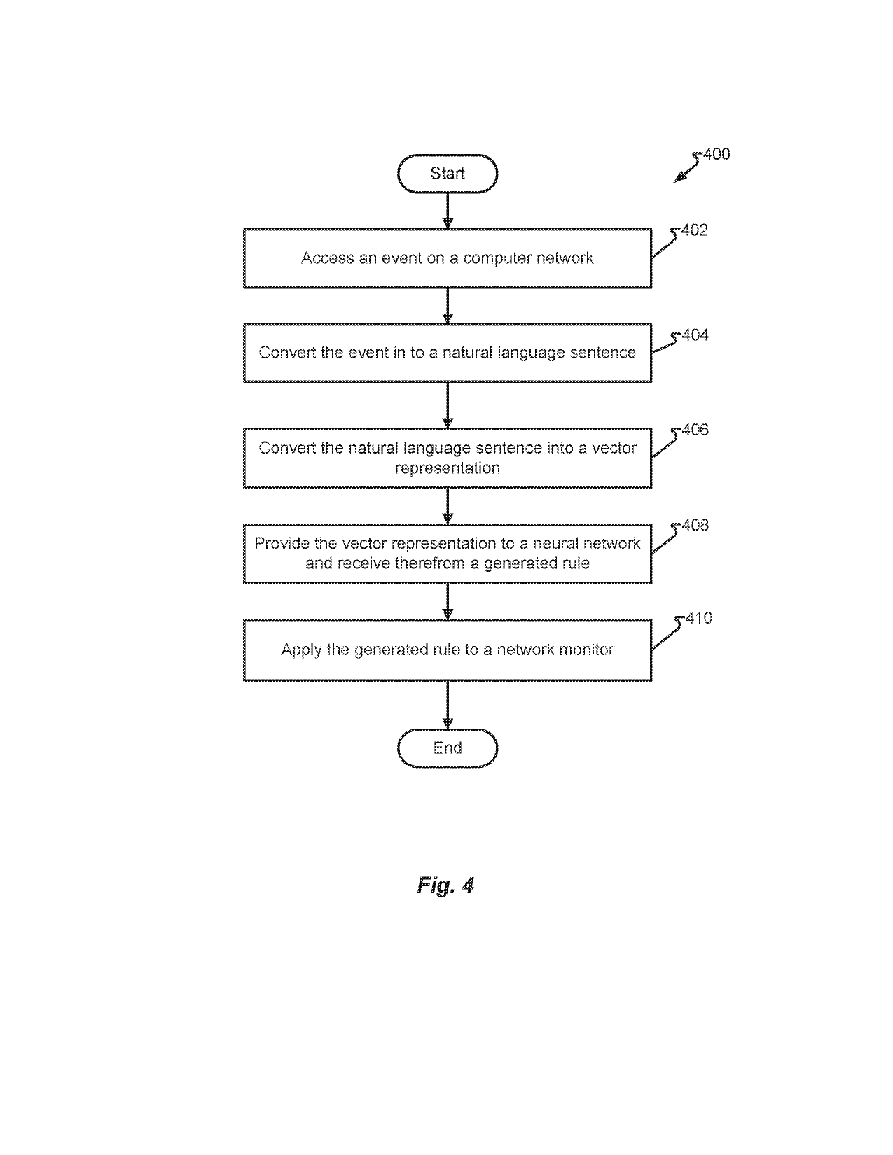

FIG. 4 depicts process 400 in accordance with embodiments of the present disclosure. In one embodiment, process 400 is embodied as machine-readable instructions maintained in a non-transitory memory that when read by a machine, such as one or more processors of a server or servers, cause the machine to execute the instructions and thereby execute process 400. The processor of the server may include, but is not limited to, at least one processor of server 106.

Process 400 begins and, in step 402, an event on a computer network is accessed. The event may be received or retrieved, such as from a component on a network (e.g., component 112 attached to network 110). Next, step 404 converts the event into a natural language sentence which, in step 406, is converted to a vector representation. Step 408 provides the vector representation to a neural network and receives therefrom a generated rule. Step 410 then applies the generated rule to a network monitor (e.g., server 106) to evaluate future events.

A neural network, in general, is known in the art and comprises self-configured layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

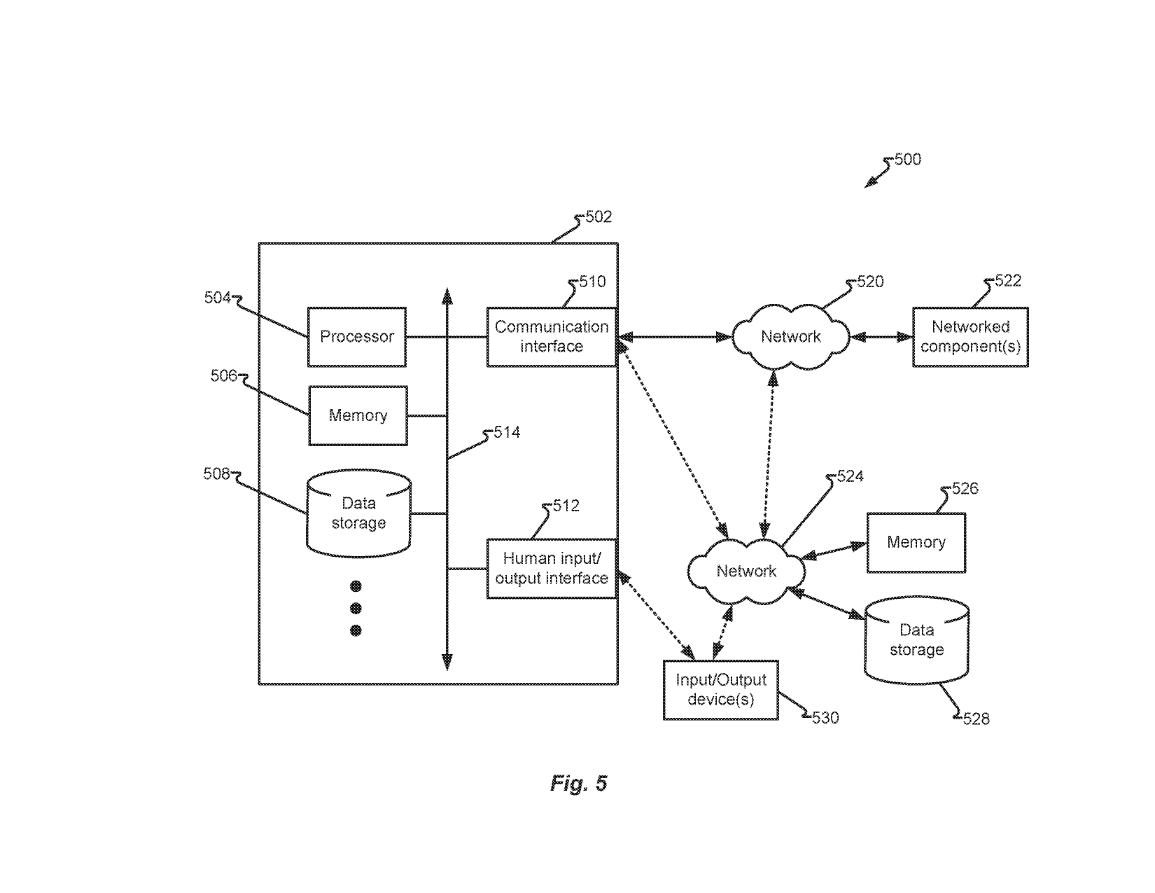

FIG. 5 depicts device 502 in system 500 in accordance with embodiments of the present disclosure. In one embodiment, server 106 and components 112A-112n may be embodied, in whole or in part, as device 502 comprising various components and connections to other components and/or systems. The components are variously embodied and may comprise processor 504. The term "processor," as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., "cloud", farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 110 (and optionally network 114) may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, "cloud," etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), "cloud", multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., "cloud" based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as "the cloud," but may include a public, private, dedicated, shared and/or other service bureau, computing service, and/or "server farm."

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, "cloud" or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable "source code" software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
accessing an event on a computer network;
converting the event into a natural language sentence;
converting the natural language sentence into a vector representation;
embedding a number of events associated with the event into the vector representation;
providing the vector representation to a neural network and, in response, receiving a generated rule therefrom; and
applying the generated rule to a network monitor receiving events from the computer network and evaluating the events with the generated rule.

2. The method of claim 1, wherein converting the event into the natural language sentence comprises providing the event to a large language model (LLM) and receiving therefrom the natural language sentence.

3. The method of claim 1, wherein converting the natural language sentence into the vector representation further comprises providing the natural language sentence to a sentence transformer and receiving therefrom the vector representation.

4. The method of claim 1, further comprising:
training the neural network comprising providing the neural network with the vector representation and receiving therefrom a number of nodes, each node of the number of nodes corresponding to a correlation rule currently deployed in the computer network.

5. The method of claim 4, wherein training the neural network further comprises providing a number of vector representations to the neural network, further comprising providing at least the vector representation and a number of correlation rules comprising at least the correlation rule associated with the event to the neural network.

6. The method of claim 4, wherein training the neural network further comprises providing the neural network with the number of events correlated with the corresponding correlation rule of the number of correlation rules that were triggered by the event.

7. The method of claim 1, wherein receiving the event comprises receiving a number of prior events from the computer network, evaluating at least one of the number of prior events with at least one existing rule, and receiving the event from the evaluation thereof.

8. The method of claim 1, wherein converting the event into the natural language sentence comprises converting the event into a complete sentence comprising a subject and a predicate.

9. A system, comprising:
a network interface to a computer network; and
a microprocessor coupled to a computer memory comprising instructions that, when read by the microprocessor, cause the microprocessor to perform:
accessing, via the network interface, an event on the computer network;
converting the event into a natural language sentence;
converting the natural language sentence into a vector representation;
embedding a number of events associated with the event into the vector representation;
providing the vector representation to a neural network and, in response, receiving a generated rule therefrom; and
applying the generated rule to a network monitor receiving events from the computer network and evaluating the events with the generated rule.

10. The system of claim 9, wherein converting the event into the natural language sentence comprises providing the event to a large language model (LLM) and receiving therefrom the natural language sentence.

11. The system of claim 9, wherein converting the natural language sentence into the vector representation further comprises providing the natural language sentence to a sentence transformer and receiving therefrom the vector representation.

12. The system of claim 9, further comprising:
training the neural network comprising providing the neural network with the vector representation and receiving therefrom a number of nodes, each node of the number of nodes corresponding to a correlation rule currently deployed in the computer network.

13. The system of claim 12, wherein training the neural network further comprises providing a number of vector representations to the neural network, further comprising providing at least the vector representation and a number of correlation rules comprising at least the correlation rule associated with the event to the neural network.

14. The system of claim 12, wherein training the neural network further comprises providing the neural network with the number of events correlated with the corresponding correlation rule of the number of correlation rules that were triggered by the event.

15. The system of claim 9, wherein receiving the event comprises receiving a number of prior events from the computer network, evaluating at least one of the prior events with at least one existing rule, and receiving the event from the evaluation thereof.

16. A non-transitory computer readable medium comprising instructions that, when read by a machine, cause the machine to perform:
accessing an event on a computer network;
converting the event into a natural language sentence;
converting the natural language sentence into a vector representation;
embedding a number of events associated with the event into the vector representation;
providing the vector representation to a neural network and, in response, receiving a generated rule therefrom; and
applying the generated rule to a network monitor receiving events from the computer network and evaluating the events with the generated rule.

17. The non-transitory computer readable medium of claim 16, wherein the instructions to cause the machine to perform converting the event into the natural language sentence further comprise instructions to cause the machine to perform providing the event to a large language model (LLM) and receive therefrom the natural language sentence.

18. The non-transitory computer readable medium of claim 16, wherein instructions to cause the machine to perform converting the natural language sentence into the vector representation further comprise instructions to cause the machine to perform providing the natural language sentence to a sentence transformer and receive therefrom the vector representation.

19. The non-transitory computer readable medium of claim 16, further comprising instructions to cause the machine to perform training the neural network comprising providing the neural network with the vector representation and receiving therefrom a number of nodes, each node of the number of nodes corresponding to a correlation rule currently deployed in the computer network.

20. The non-transitory computer readable medium of claim 16, wherein the natural language sentence comprises converting the event into a complete sentence comprising a subject and a predicate.
